(19) United States
(12) Patent Application Publication
(10) Pub. No.: US 2022/0360850 A1
(43) Pub. Date: Nov. 10, 2022

(54) COGNITIVE COMPUTER CONTROLLED DISPLAY OF DIGITAL CONTENT TO AVOID UNWANTED DISPLAY CAPTURE

(71) Applicant: International Business Machines Corporation, Armonk, NY (US)

(72) Inventors: Norton Samuel Augustus Stanley, Bangalore (IN); Josephine E. Justin, Bangalore (IN)

(21) Appl. No.: 17/302,593

(22) Filed: May 7, 2021

(51) Int. Cl. H04N 21/442; G06N 3/04; G06N 3/08

(52) U.S. Cl. CPC H04N 21/44236; H04N 21/44204; H04N 21/44218; G06N 3/04; G06N 3/08

(57) ABSTRACT

A computer presents digital content securely. The computer identifies a display device presenting digital content to an observation zone. The computer receives a feed from a sensor monitoring the observation zone. The computer identifies content of the feed using a convolutional neural network (CNN). The computer, upon detecting a trigger condition associated with said observation zone in response the identification by the CNN, takes at least one substantially-contemporaneous remedial action.

### BACKGROUND

The present invention relates generally to the field of displaying digital content securely, and more specifically, to managing display of digital content to prevent unwanted capture.

Computer systems often contain displays that allow content to be distributed to a wide audience. In some situations, the audience may be distributed among multiple locations. It is even possible to reach audiences at different times if desired. This flexibility makes distributing digital content convenient , while also raising some possible concerns. For example, some digital content may include information not suitable for general distribution (e.g., trade secrets, etc.), and it can be difficult to ensure the content is only reaching the intended audience. The flexibility of and repeatability of modern digital content sharing makes it difficult to ensure sensitive content is not captured without permission and passed along to unintended audiences.

### SUMMARY

In embodiments according to the present invention, a computer implemented method to present digital content securely includes identifying, by a computer, a display device presenting digital content to an observation zone. The computer receives a feed from a sensor monitoring the observation zone. The computer identifies content of the feed using a convolutional neural network (CNN). The computer, upon detecting a trigger condition associated with said observation zone, in response to identification by the CNN, takes at least one substantially-contemporaneous remedial action. According to aspects of the invention, the remedial action is selected from a group consisting of obscuring an element of the digital content, removing a selected element from the digital content, and sending an alert signal to a source of said digital content. According to aspects of the invention, the trigger condition includes the presence of a recording device within the observation zone. According to aspects of the invention, the computer receives an indication of a maximum participant quantity for the said observation zone, the trigger condition is a quantity of audience members exceeding said maximum audience size. According to aspects of the invention, the CNN is selected from options including Histogram of Oriented Gradients (HOG), Region-based Convolutional Neural Networks (R-CNN), Fast R-CNN, Faster R-CNN, Region-based Fully Convolutional Network (R-FCN), Single Shot Detector (SSD), Spatial Pyramid Pooling (SPP-net), and YOLO (You Only Look Once) algorithms. According to aspects of the invention, the method includes detecting at least one startup condition associated with the observation zone, including a quantity of audience members equaling or being below a maximum participant quantity and the feed having a predetermined feed quality attribute value meeting a feed quality acceptability threshold, and the display device presents said digital content in response to detecting said at least one startup condition. According to aspects of the invention, the trigger condition is selected options including a quantity of audience members exceeding a predetermined maximum participant quantity and the predetermined feed quality attribute value falling below the feed acceptability threshold.

In another embodiment of the invention, a system to presenting digital content securely, includes a computer system comprising a computer readable storage medium having program instructions embodied therewith, the program instructions executable by a computer to cause the computer to: identify a display device presenting digital content to an observation zone; receive a feed from a sensor monitoring the observation zone; identify content of said feed using a convolutional neural network (CNN); and responsive to said identification by said CNN, upon detecting a trigger condition associated with said observation zone, take at least one substantially-contemporaneous remedial action.

In another embodiment of the invention, a computer program product to present digital content securely, includes computer readable storage medium having program instructions embodied therewith, the program instructions executable by a computer to cause the computer to: identify, using a computer, a display device presenting digital content to an observation zone; receive, using the computer, a feed from a sensor monitoring the observation zone; identify, using the computer, content of said feed using a convolutional neural network (CNN); and responsive to said identification by said CNN, upon detecting a trigger condition associated with said observation zone, take at least one substantially-contemporaneous remedial action.

The present disclosure recognizes and addresses the shortcomings and problems associated with displaying digital content in computerized environments where cameras or other capture devices could be used to take pictures of a screen containing sensitive information. The present disclosure recognizes and addresses the shortcomings and problems associated with presenting sensitive material to audiences located remote from the content presenter.

Aspects of the present invention, help keep selected elements of the digital content (e.g., sensitive or confidential information, trades secrets, etc.) safe from unwanted capture during computer activities that involve screensharing, such as online meetings, collaborative discussions, remote troubleshooting, etc.) an issue. Aspects of the invention monitor the area in which the information is displayed (e.g., an observation zone) and reduce the likelihood that the displayed information is captured by a recording device or seen by an audience that is too large. Aspects of the invention delay content presentation or obscure content delivery until an acceptable monitor feed signal is present and acceptable observation zone conditions are established. According to aspects of the invention, if a screen capture device (e.g., a camera, portable phone with camera, etc.) or an audience exceeding a maximum participant size is detected, at least one remedial action (including blurring or otherwise obscuring display content or notifying a presenter) to protect the content. According to aspects of the invention, selected portions pre-determined as sensitive (e.g., confidential information, trade secrets, etc.) can be obscured, while public information remains visible.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are set forth as below as:

FIG. 1 is a schematic block diagram illustrating an overview of a system for securely displaying digital content that interrupts the display of content when trigger conditions are detected according to aspects of the invention.

FIG. 2 is a flowchart illustrating a method, implemented using the digital content distribution system shown in FIG. 1, that interrupts the display of content when trigger conditions are detected according to aspects of the invention.

FIG. 3 is a schematic representation of aspects of an observation zone and associated components of the system shown in FIG. 1.

FIG. 4 is a flowchart illustrating alternate aspects of a method implemented using the digital content distribution system shown in FIG. 1 that interrupts the display of content when trigger conditions are detected according to aspects of the invention.

FIG. 5 is a schematic block diagram depicting a computer system according to an embodiment of the disclosure which may be incorporated, all or in part, in one or more computers or devices shown in FIG. 1, and cooperates with the systems and methods shown in FIG. 1.

FIG. 6 depicts a cloud computing environment according to an embodiment of the present invention.

FIG. 7 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a participant” includes reference to one or more of such participants unless the context clearly dictates otherwise.

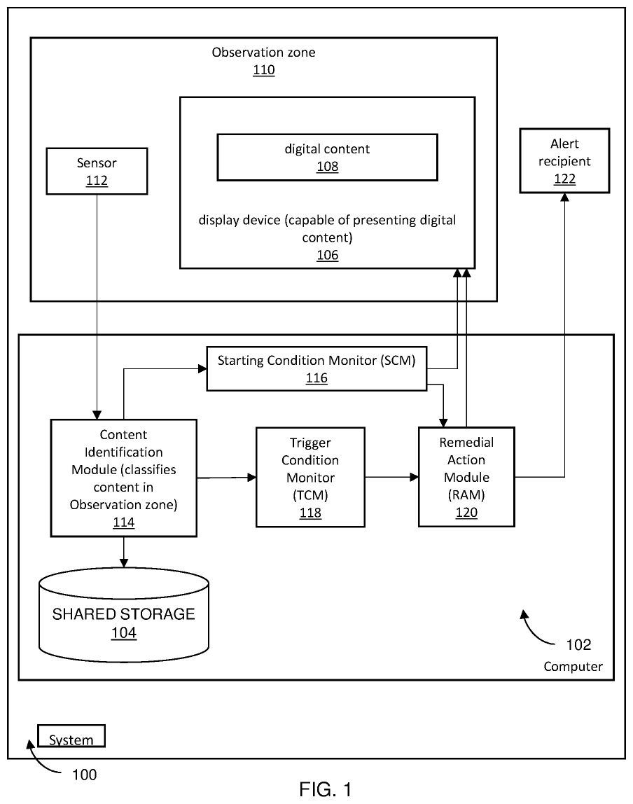

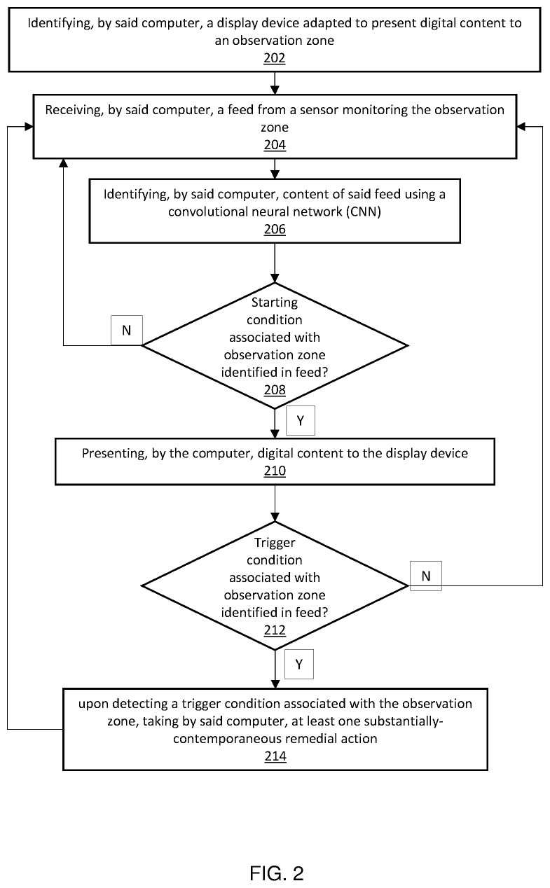

Now with combined reference to the Figures generally and with particular reference to FIG. 1 and FIG. 2, an overview of a method for securely displaying digital content that interrupts the display of content when unwanted recording devices or audience members are detected usable within a system 100 as carried out by a server computer 102 having optionally shared storage 104 is provided. The server computer 102 is in operative cooperation with a display device 106 capable of displaying digital content 108 (e.g., such as during a presentation, live meeting, etc.) when selected conditions in an associated observation zone 110 (e.g., such as an area in front of, surrounding, or otherwise near enough for the digital content to be seen) are present. The server computer 102 is operative connection with a sensor 112 (e.g., a camera or similar device) that monitors the observation zone 110 and sends an ongoing, substantially real-time video feed of activity in the observation to a Content Identification Module (CIM) 114 of the server computer 102. According to aspects of the invention, the observation zone 110 includes the entire area from which content presented by the display device 106 may be seen, and more than one sensor 112 may be used as appropriate.

According to aspects of the invention, the CIM 114 processes the feed content from the sensor 112 and uses image and video recognition techniques to identify conditions in the observation zone 110. According to aspects of the invention, the CIM 114 uses a convolutional neural network (CNN) to provide substantially-real-time classification of items in the observation zone 110, sending this information to downstream condition monitors 116,118 for further processing.

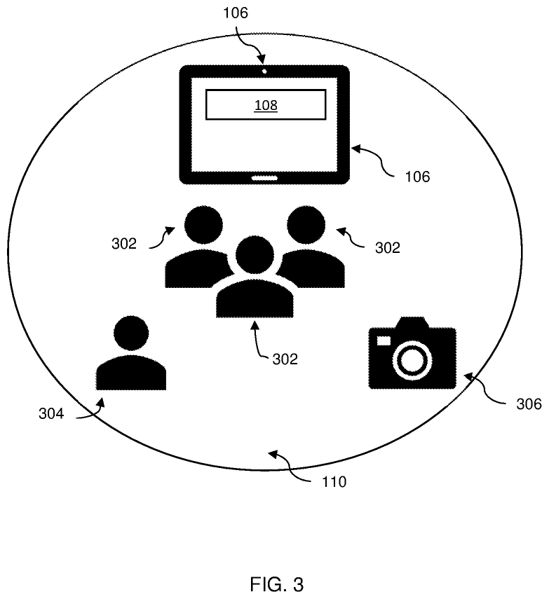

The server computer includes Starting Condition Monitor (SCM) 116 that receives information from the CIM 114 about classified items in the observation zone 110. During operation, the SCM 116 looks for certain conditions to be present in the observation zone 110, including of a quantity of audience members (e.g., 302,304 as seen in FIG. 3) equaling or being below a maximum participant quantity and whether the feed meets a feed quality acceptability threshold. According to aspects of the invention, the SCM 116 is responsible for the display device 106 displaying the digital content 108. Without the starting conditions being met, the server computer 102 will not direct the display device 106 to display content 108. In an embodiment, the SCM 116 will direct remedial action module 120 to send a message to an alert recipient 122, indicating that certain starting conditions have not been met.

The server computer includes Trigger Condition Monitor (TCM) 118 that receives information from the CIM 114 about classified items in the observation zone 110. During operation, the TCM 118 looks for certain conditions to be present in the observation zone 110, including of a quantity of audience members 302, 304 exceeding a maximum participant quantity and the presence of a recording device. According to aspects of the invention, the server computer 102 will interrupt the display of content 108 when trigger conditions are met.

More particularly, the TCM 118 directs remedial Action Module 120 to take one or more predetermined actions to prevent the unwanted capturing (and even in some cases, the continued display) of digital content 108 when trigger conditions (e.g., an audience exceeding a maximum participant quantity and the presence of a recording device 306, as seen in FIG. 3) occur in the observation zone 110, so that the content is neither captured (nor observed) in a non-permitted manner. As shown in FIG. 3, the observation zone 110 may include a predetermined acceptable maximum number of audience members 304 (e.g., three or fewer, as selected by a presenter or other user with skill in this field), as well as extra audience members 304 beyond the predetermined maximum. According to aspects of the invention, the server computer 102 stores, in shared storage 194 a maximum audience size and passes this value to the SCM 116 and 118 for consideration during operation. In cases where the number of audience member exceeds a predetermined audience maximum size, the server computer 102 will determine one of the starting conditions has not been met, and a presenter (e.g., alert recipient 122) may be notified to adjust the audience, adjust the standard, or take some other corrective action associated with the unmet condition.

In an embodiment, the TCM 120 may direct the RAM 120 to send an alert message to an alert recipient 122. It is noted that the alert recipient 122 may take further actions (e.g., including asking audience to put away the noted capture device, to request that extra participants 304 leave the audience, to grant permission in extenuating circumstances, or other actions deemed appropriate by one skilled in this field) to manage dissemination of the digital content 108 and to keep selected content secure.

Now with specific reference to FIG. 2, and to other figures generally, a method for securely displaying digital content by interrupting the display of content when unwanted recording devices or audience members are detected will be described. The server computer 102 at block 202 , identifies a display device adapted to present digital content to an observation zone 110. According to aspects of the invention, the display device 106 may be a laptop computer screen, a desktop monitor, laptop display, cell phone display, projector, or any other device capable of presenting digital content 108 to the monitored observation zone 110.

The server computer 102, receives in block 204 a feed a from a sensor 112 monitoring the observation zone 110. According to aspects of the invention, the sensor 112 includes at least one camera 106 positioned to capture a real-time video signal of sufficient quality that an assessment of observation zone 110 content may be made by Content Identification Module 114. In particular, the server computer 102 confirms, as starting conditions, the presence of an active, real-time signal associated with the observation zone 112 meeting a quality acceptability threshold. According to aspects of the invention, a preferred threshold includes a minimum image resolution of 360p (or equivalent) and acceptable ambient light quantity measured by an ambient light detector available to the server computer 102. A preferred acceptable ambient light quantity is in the range of 100-700 lux, and this range may be adjusted in accordance with the judgment of one skilled in this field.

It is also noted that the assessment of sensor feed quality may be made manually, by a remote presenter who confirms that starting conditions are met before sharing content. According to aspects of the invention, in addition to the standards listed above, various signal resolutions, light qualities, and qualitative preferences regarding the signal and observation zone content (including, e.g., signal timeliness, a confirmation that no recording devices are present, that a total audience member count is below an accepted maximum value, etc.) may be deemed acceptable by a presenter or other users skilled in this field and starting conditions may be selected in accordance with those preferences.

It is noted that although a real-time signal feed is preferred to ensure actions taken by the server computer 102 are contemporaneous (occur close enough in time to allow preventative interaction as needed to prevent unwanted content capture or presentation to unwanted audiences) remedial actions can still be taken when the feed lags. As used herein, the terms “real-time” and “contemporaneous” includes lags of up to 5 seconds (or other period deemed acceptable by one skill in this field, selected in accordance with the nature of expected recording devices 306, the nature of the display device 106, and nature of audiences within the observation zone 110).

The server computer 102, via Content Identification Module (CIM) 114 at block 206, identifies content of the sensor feed using a convolutional neural network (CNN). In particular, the CIM 114 receives the feed from sensor 106 and processes the content to identify objects, 302, 304, 306 within the observation zone 110. According to aspects of the invention, CIM 110 includes a Machine Learning (ML) model trained to identify images of video capture devices (including cameras generally, cell phones in a recording orientation, and other devices present in the ML training data) in the sensor feed. According to aspects of the invention, the CIM 110 ML model is also trained to determine a quantity of audience members 302,304 in the observation zone 110.

Although many recognition approaches may suffice, it is noted that use of a convolutional neural network (CNN) is preferred, due to the suitability of CNNs for visual image recognition. According to aspects of the invention, preferred CNNs are based, at least in part, on Histogram of Oriented Gradients (HOG), Region-based Convolutional Neural Networks (R-CNN), Fast R-CNN, Faster R-CNN, Region-based Fully Convolutional Network (R-FCN), Single Shot Detector (SSD), Spatial Pyramid Pooling (SPP-net), and YOLO (You Only Look Once) algorithms.

The server computer 102 passes information about the feed content identified by the CIM 114 (e.g., presence of recording devices 306, quantity of audience members 302,304, and information about the suitability of the signal quality) to the Starting Condition Monitor (SCM) 116. At block 208, the server computer 102 determines whether pre-established starting conditions are met.

In an embodiment, the SCM 116 determines whether an acceptable (as described above) signal feed from sensor 112 is present and whether an acceptable number of audience members 302 is present. It is noted, that the SCM 116 may also proactively ensure that the observation zone 110 is free from unwanted recording devices 306 as a starting condition.

When the server computer 102, via SCM 116 determines the starting conditions are met, the server computer directs the display device 106, at block 210, to present content 108. The server computer 102, via the sensor 106 and CIM 114, continues to monitor the observation zone 110, making real-time assessments regarding activity occurring, items 306 present, and audience size 302,304 in the observation zone.

The server computer 102 continues displaying content 108 until content presentation is complete or until, at block 212, the server computer determines a trigger condition has been met. In particular, during ongoing operation, the server computer 102 sends data (e.g., information about the audience size 302, 304 and items 306 within the observation zone 110) from the CIM 114 to the Trigger Condition Monitor 118, so that content 108 may be protected, if one or more trigger occur.

In an embodiment, the TCM 118 determines whether an unacceptable number of audience members 304 is present and ensures that the observation zone 110 is free from unwanted recording devices 306. According to aspects of the invention, if either too many audience members 302,304 are present, or if unwanted recording devices 306 are present (or other predetermined conditions as appropriate by one skilled in this field), the TCM 118 will indicate that a trigger condition has been met. In an embodiment, the trigger conditions may also include the predetermined feed quality attribute value falling below the feed acceptability threshold. If no trigger conditions are present, control returns to block 204, with content 108 presentation and observation zone 110 assessment continuing.

When the TCM 118 indicates a trigger condition has been met, the server compute 102, via Remedial Action Module (RAM) 120 at block 214, takes action to protect selected elements (e.g., sensitive portions) of content 108 being presented. In particular, the RAM 120 will, in a substantially-real-time fashion, take an action contemporaneous with the trigger condition occurrence. Preferred actions include screen blurring (e.g., applying a Gaussian blur or similar techniques) or otherwise obscuring (e.g., with partial screen overlays, etc.) the output of the display device 106 (e.g., the portion showing content 108 to be protected), completely blanking the display device, and sending an alert signal to an alert recipient 122 (e.g., a content presenter or other user able to interrupt the display of content to be protected). It is noted that the server computer may direct the RAM 120 to undertake various combinations of remedial action when trigger conditions are met. For example, a signal may be sent to an alert recipient 122 when screen content 10 may be obscured.

The server computer 102 returns flow control to block 204 after taking remedial action in block 214, so that conditions in the observation zone 110 can be reassessed. With this approach, the server computer 102 provides a cognitive response to unwanted conditions, allowing interrupted content presentation to continue, when meaningful corrective action (such as removal of unwanted audience members 304 or recording devices 306) has occurred.

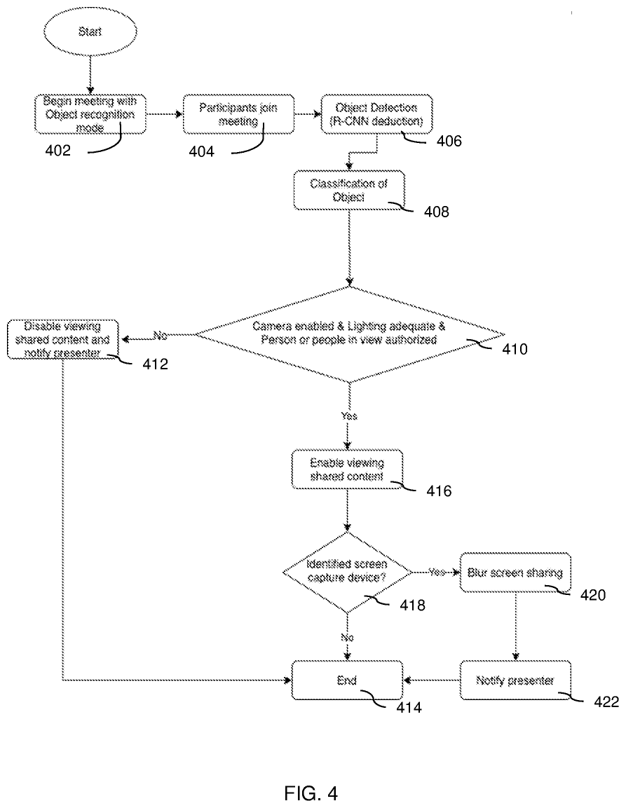

Now with respect to FIG. 4, alternate aspects of the method of the present invention that interrupts the display of content when trigger conditions are detected will be described. In block 402, the server computer 102 starts a meeting to present content 108 in an object recognitions mode (e.g., to monitor the observation zone 110).

At block 404, the server computer 102 identifies participants (e.g., audience members 302, 304). At block 406, the Content Identification Manager 114 receives a feed from the sensor 112, and the CIM, in block 408, classifies objects 302, 304, 306 detected in the feed.

The server computer 102, via the Starting Condition Monitor (SCM) 116 at block 410, determines whether predetermined staring conditions are met. In an embodiment, the SCM 116 confirms whether the camera (e.g., sensor 112) is activated, assesses feed quality attributes (e.g., including adequacy of image lighting), and determines whether the audience more audience members 304 that are permitted 302).

In an embodiment, if the server computer 102 via SCM 116 determines that the starting conditions are not met, the server computer may, via Remedial Action Module (RAM) 120 at block 412, terminate the meeting (e.g., interrupt the display of content 108), as a remedial action to protect the content at block and end the presentation at block 414. In an embodiment, if the server computer 102 via SCM 116 determines that the starting conditions are met, the server computer will direct the display device to present shared digital content 108.

During operation, the server computer 102 may, via Trigger Condition Module 118 at block 418, identify one or more trigger conditions (e.g., the presence of a capture device 306) and may, via RAM 120 take remedial actions. For example, the RAM 120 may at block 420, interrupt the display of content 108 (e.g., by blurring a portion of the content, blanking the display completely, etc.) and in block 422 notify an alert recipient 122 (e.g., a presenter or other user capable of taking action to protect the displayed content).

Regarding the flowcharts and block diagrams, the flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

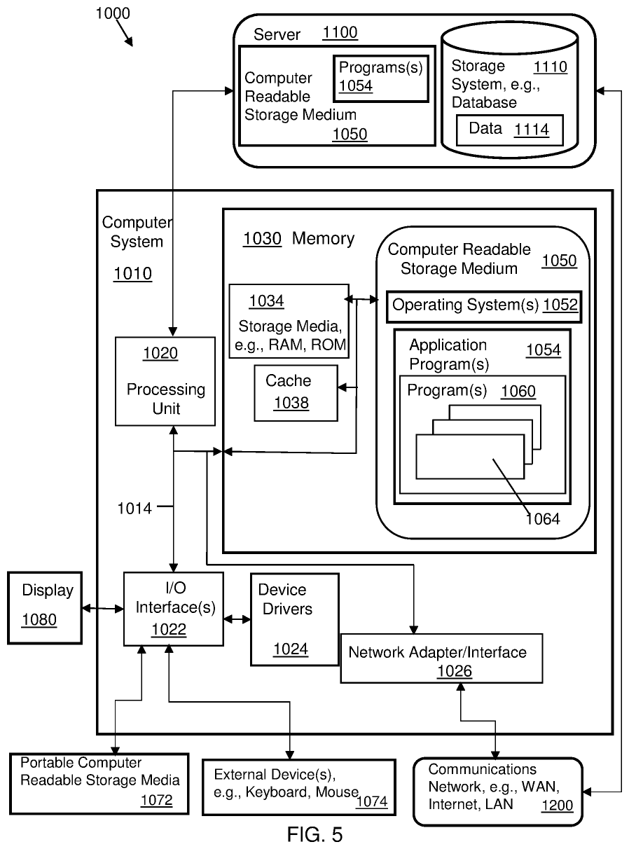

Referring to FIG. 5, a system or computer environment 1000 includes a computer diagram 1010 shown in the form of a generic computing device. The method of the invention, for example, may be embodied in a program 1060, including program instructions, embodied on a computer readable storage device, or computer readable storage medium, for example, generally referred to as memory 1030 and more specifically, computer readable storage medium 1050. Such memory and/or computer readable storage media includes non-volatile memory or non-volatile storage. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure.

One or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

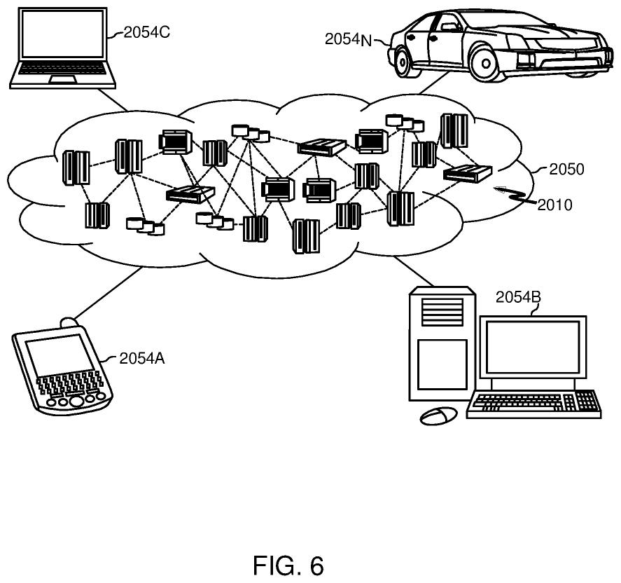

Referring now to FIG. 6, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 6 are intended to be illustrative only and that computing nodes 2010 and cloud computing environment 2050 can communicate with any type of computerized device over any type of network and/or network addressable connection (e.g., using a web browser).

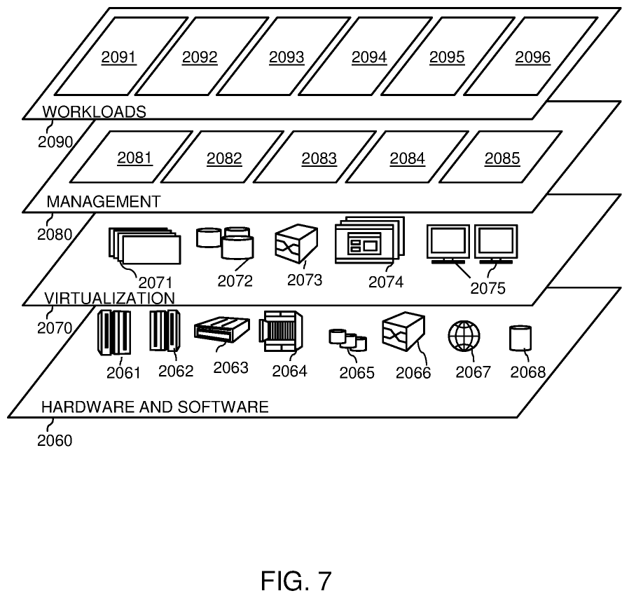

Referring now to FIG. 7, a set of functional abstraction layers provided by cloud computing environment 2050 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and securely displaying digital content 2096.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method to present digital content securely, comprising:
identifying, by a computer, a display device presenting digital content to an observation zone;
receiving, by said computer, a feed from a sensor monitoring the observation zone;
identifying, by said computer, content of said feed using a convolutional neural network (CNN); and
responsive to said identification by said CNN, upon detecting a trigger condition associated with said observation zone, taking by said computer, at least one substantially-contemporaneous remedial action.

2. The method of claim 1 wherein, said remedial action is selected from a group consisting of obscuring an element of the digital content, removing a selected element from the digital content, and sending an alert signal to a source of said digital content.

3. The method of claim 1 wherein, said trigger condition includes the presence of a recording device within said observation zone.

4. The method of claim 1 further including receiving, by said computer, an indication of a maximum participant quantity for said observation zone; and wherein said trigger condition is a quantity of audience members exceeding said maximum audience size.

5. The method of claim 1 wherein said CNN is selected from a group consisting of Histogram of Oriented Gradients (HOG), Region-based Convolutional Neural Networks (R-CNN), Fast R-CNN, Faster R-CNN, Region-based Fully Convolutional Network (R-FCN), Single Shot Detector (SSD), Spatial Pyramid Pooling (SPP-net), and YOLO (You Only Look Once).

6. The method of claim 1 further including:
detecting at least one startup condition associated with said observation zone selected from a group consisting of a quantity of audience members equaling or being below a maximum participant quantity and said feed having a predetermined feed quality attribute value meeting a feed quality acceptability threshold; and
wherein said display device presents said digital content in response to detecting said at least one startup condition.

7. The method of claim 6 wherein, said trigger condition is selected from a group consisting of said quantity of audience members exceeding said maximum participant quantity and said predetermined feed quality attribute value falling below said feed acceptability threshold.

8. A system to optimize input component enablement for presenting digital content securely, which comprises:
a computer system comprising a computer readable storage medium having program instructions embodied therewith, the program instructions executable by a computer to cause the computer to:
identify a display device presenting digital content to an observation zone;
receive a feed from a sensor monitoring the observation zone;
identify content of said feed using a convolutional neural network (CNN); and
responsive to said identification by said CNN, upon detecting a trigger condition associated with said observation zone, take at least one substantially-contemporaneous remedial action.

9. The system of claim 8 wherein, said remedial action is selected from a group consisting of obscuring an element of the digital content, removing a selected element from the digital content, and sending an alert signal to a source of said digital content.

10. The system of claim 8 wherein, said trigger condition includes the presence of a recording device within said observation zone.

11. The system of claim 8 further including receiving, by said computer, an indication of a maximum participant quantity for said observation zone; and wherein said trigger condition is a quantity of audience members exceeding said maximum audience size.

12. The system of claim 8 wherein said CNN is selected from a group consisting of Histogram of Oriented Gradients (HOG), Region-based Convolutional Neural Networks (R-CNN), Fast R-CNN, Faster R-CNN, Region-based Fully Convolutional Network (R-FCN), Single Shot Detector (SSD), Spatial Pyramid Pooling (SPP-net), and YOLO (You Only Look Once).

13. The system of claim 8 further including:
detecting at least one startup condition associated with said observation zone selected from a group consisting of a quantity of audience members equaling or being below a maximum participant quantity and said feed having a predetermined feed quality attribute value meeting a feed quality acceptability threshold; and
wherein said display device presents said digital content in response to detecting said at least one startup condition.

14. The system of claim 13 wherein, said trigger condition is selected from a group consisting of said quantity of audience members exceeding said maximum participant quantity and said predetermined feed quality attribute value falling below said feed acceptability threshold.

15. A computer program product to present digital content securely, the computer program product comprising a computer readable storage medium having program instructions embodied therewith, the program instructions executable by a computer to cause the computer to:
identify, using a computer, a display device presenting digital content to an observation zone;
receive, using the computer, a feed from a sensor monitoring the observation zone;
identify, using the computer, content of said feed using a convolutional neural network (CNN); and
responsive to said identification by said CNN, upon detecting a trigger condition associated with said observation zone, take at least one substantially-contemporaneous remedial action.

16. The computer program product of claim 15 wherein, said remedial action is selected from a group consisting of obscuring an element of the digital content, removing a selected element from the digital content, and sending an alert signal to a source of said digital content.

17. The computer program product of claim 15 wherein, said trigger condition includes the presence of a recording device within said observation zone.

18. The computer program product of claim 15 further including receiving, by said computer, an indication of a maximum participant quantity for said observation zone; and wherein said trigger condition is a quantity of audience members exceeding said maximum audience size.

19. The computer program product of claim 15 further including:
detecting at least one startup condition associated with said observation zone selected from a group consisting of a quantity of audience members equaling or being below a maximum participant quantity and said feed having a predetermined feed quality attribute value meeting a feed quality acceptability threshold; and
wherein said display device presents said digital content in response to detecting said at least one startup condition.

20. The computer program product of claim 19 wherein, said trigger condition is selected from a group consisting of said quantity of audience members exceeding said maximum participant quantity and said predetermined feed quality attribute value falling below said feed acceptability threshold.
